(19) United States
(12) Patent Application Publication
(10) Pub. No.: US 2010/0300812 A1
(43) Pub. Date: Dec. 2, 2010

(54) Forklift Clamp

(75) Inventors: Jack F. Hall, Interlachen, FL (US); Ralph E. Hopkins, Elkton, FL (US)

Correspondence Address: Georgia-Pacific LLC, 133 Peachtree Street NE - GA030-41, ATLANTA, GA, 30303, US

(73) Assignee: Georgia-Pacifica Consumer Products LP, Atlanta, GA (US)

(21) Appl. No.: 12/473,589

(22) Filed: May 28, 2009

(51) Int. Cl. B66F 9/18

(52) U.S. Cl. 187/237

(57) ABSTRACT

Described herein are devices and methods for transporting a plurality of palletless product units at a single time. A palletless product handling vehicle comprising two clamping pads capable of being positioned on either side of a plurality of product units maintained in side-by-side relation can be used to transport the product units during manufacturing, distribution, and storage processes. The clamping members can be maintained at a neutral camber, open to a distance of at least 96 inches, and close to a distance of about 28 inches or less. As a result of the camber, the improved mobility of the clamping members, and the improved clamping pads, two or more palletless product units can be transported in side-by-side relation at one time without causing damage or creasing to the product units. Thus, more efficient and cost-effective transportation of product units and product storage can be achieved.

### BACKGROUND OF THE INVENTION

Conventional palletless handling is a technique that may be employed during the manufacturing, shipping, and storage phases of product distribution. It may be used to move large quantities of product from one location to another. Rather than using a standard forklift comprising two or more forwardly-extending prongs, which extend into a pallet supporting a unit of product, the technique involves equipping a product handling vehicle with a pair of vertically oriented pads that are capable of squeezing the product from either side and then lifting it off the ground in preparation of product transport. One advantage of this method for moving product is the elimination of the pallet. This results in less stress on the product handling equipment, as less weight is being transported, and an increase in storage space, since the pallet is no longer present underneath the product units.

One drawback to conventional palletless handling, however, is the reduced quantity of product that can be moved at one time. This is particularly the case in the transportation of delicate products, such as paper and tissue. In such a case, only a single unit of product can be transported at one time. A conventional palletless product transport vehicle is not able to handle two separate units of product in side-by-side fashion. And, even if it did, the force required to lift two units using conventional methods and vehicles would be so great that the product being transported could be easily damaged or creased.

Accordingly, current palletless product manufacturing, distribution, and storage could benefit from improved techniques and devices for transporting palletless products between various locations.

### SUMMARY OF THE INVENTION

Described herein is a palletless product handling vehicle for use in the transport of multiple units of palletless product. The handling vehicle comprises a motorized vehicle, a mounting bracket coupled to the vehicle, and a pair of clamping members couple to the mounting bracket. Generally, each of the clamping members can be positioned on either side of a plurality of palletless product units that are maintained in side-by-side relation, clamp down on the product units, and transport them to another location.

In one aspect, the clamping members can open to a distance of about 96 inches or more and close to a distance of about 28 inches or less, and the clamping members can be maintained at a neutral camber to facilitate the transportation of two or more product units at a single time without creasing or otherwise causing damage to the product.

In another aspect, the handling vehicle described herein can be used in the transportation and storage of paper or tissue product units where the product can be easily damaged or creased. However, the devices and methods described herein are not limited to paper and tissue product applications.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a side view of one embodiment of a palletless product handling vehicle disclosed herein.

FIG. 2 is a front view of one embodiment of a palletless product handling vehicle disclosed herein.

FIG. 3A is a side view of one embodiment of a component of a palletless product handling vehicle disclosed herein.

FIG. 3B is a front view of one embodiment of a component of a palletless product handling vehicle disclosed herein.

FIG. 4 is a front view of one embodiment of a palletless product handling vehicle disclosed herein.

FIG. 5 is a front view of one embodiment of a palletless product handling vehicle disclosed herein.

FIG. 6A is a front view of one embodiment of a palletless product handling vehicle disclosed herein.

FIG. 6B is a front view of one embodiment of a palletless product handling vehicle disclosed herein.

FIG. 6C is a front view of one embodiment of a palletless product handling vehicle disclosed herein.

FIG. 7 is a front view of one embodiment of a palletless product handling vehicle disclosed herein.

FIG. 8 is an aerial view of an exemplary palletless product storage facility.

FIG. 9 is a flowchart depicting one embodiment of the invention disclosed herein.

### DESCRIPTION OF EXEMPLARY EMBODIMENTS

Disclosed herein are various embodiments of a palletless product handling vehicle. Generally, the vehicle allows an operator to grip, manipulate, lift, and transport multiple palletless product units at one time and in a fashion that does not risk damage to the product. Currently employed methods of palletless product transport are capable of carrying only a single product unit at one time. Transporting more than a single unit at one time is difficult because the palletless product handling vehicles currently in use do not have the horizontal wingspan to grip two or more product units at one time and, if they could, would put too great a pressure on the product and crease or damage the product during transportation. The product handling vehicle disclosed herein solves these problems by increasing the wingspan of a typical handling vehicle, increasing the surface area of the pads used to grip the palletless product, and altering the orientation of the pads, with respect to one another, in such a way that creasing or damage to the product during transport is unlikely.

While the product handling vehicle and methods described herein are primarily concerned with the transportation of palletless paper and tissue product units, one skilled in the art will appreciate that the vehicle and methods described below can be used in the transportation of various palletless products, especially those delicate in nature. Additionally, while the vehicle and methods described herein focus on the transportation of two palletless product units in side-by-side relation, one skilled in the art will appreciate that a greater number of product units, or product units in a different configuration, can be transported using the same or similar devices and methods.

Reference will now be made in detail to the exemplary embodiments of the invention, examples of which are illustrated in the accompanying drawings. Wherever possible, the same reference numbers will be used throughout the drawings to refer to the same or like parts.

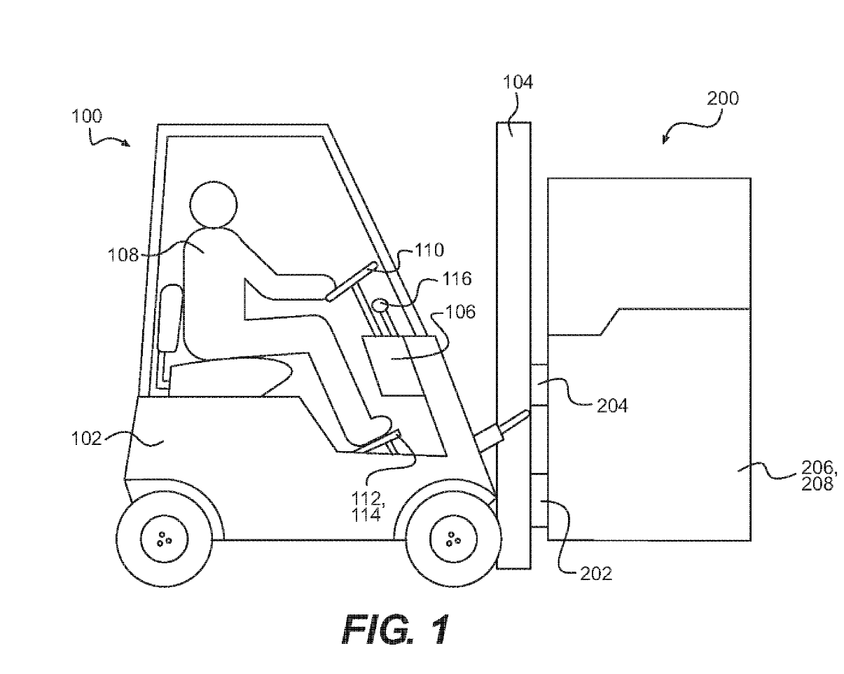

FIG. 1 illustrates one exemplary embodiment of a palletless product handling vehicle 100 for transporting palletless product units during the manufacturing, distribution, and storage processes. Product handling vehicle 100 comprises a motorized vehicle 102, a mounting bracket 104, and a palletless product unit manipulation system 200. In one aspect, vehicle 102 can include vehicle controls 106. Vehicle controls 106 can be located such that a user 108 of the vehicle can control the direction, acceleration, and braking of the motorized vehicle. In one embodiment, vehicle 102 comprises a steering wheel 110, an acceleration pedal 112, and a brake pedal 114. In another aspect, vehicle 102 can include product unit manipulation controls 116. Manipulation controls 116 can be located such that user 108 can control the movements of manipulation system 200, as will be described in further detail below. Alternatively, product unit manipulation controls 116 can be located remotely and can be used to control manipulation system 200 from a location apart from vehicle 102.

In one aspect, mounting bracket 104 is moveably coupled to vehicle 102. In one embodiment, mounting bracket 104 is coupled to vehicle 102 at its front end. In another embodiment, the mounting bracket is coupled to the vehicle's rear end. In another aspect, the mounting bracket can be coupled to the vehicle such that it is capable of vertical movement relative to the vehicle, in a plane perpendicular to the ground or operating surface. The term “operating surface,” as used herein, is intended to describe a surface supporting palletless product units prior to transportation. The term can be used to describe a facility floor, a conveyor belt carrying product units, or some other surface.

In other embodiments, mounting bracket 104 can be rotatably mounted to vehicle 102 such that the bracket can rotate about a pivot point relative to the vehicle. Alternatively, or additionally, the mounting bracket can be configured to translate horizontally with respect to the vehicle in a direction substantially parallel to the ground or operating surface.

In another aspect, manipulation system 200 is moveably coupled to mounting bracket 104. In one embodiment, manipulation system 200 comprises a pair of extendable arms 202, 204 and a pair of clamping pads 206, 208.

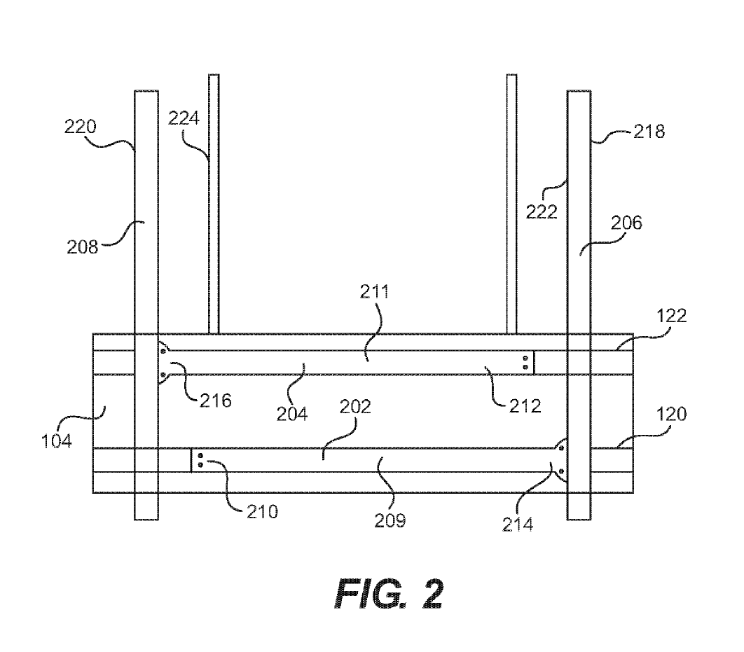

FIG. 2 depicts manipulation system 200 and mounting bracket 104 in more detail. In one aspect, extendable arms 202, 204 comprise elongate members 209, 211, respectively, having proximal ends 210, 212 and distal ends 214, 216. Proximal ends 210, 212 can be slidably coupled to mounting bracket 104 and distal ends 214, 216 can be coupled to clamping pads 206, 208. In other embodiments, manipulation system 200 can comprise two or more pairs of extendable arms. In another aspect, clamping pads 206, 208 can comprise substantially flat panels having outer surfaces 218, 220 and inner gripping surfaces 222, 224. The clamping pads are described in more detail below.

In one embodiment, mounting bracket 104 comprises slots 120 and 122 extending horizontally and at least partially housing extendable arms 202, 204, respectively. In one aspect, extendable arm 202 can slide along slot 120 in a first direction, outward from the center of mounting bracket 104 and in a plane perpendicular to both the operating surface and the plane occupied by clamping pads 206, 208. Similarly, extendable arm 204 can slide along slot 122 in a second, opposite direction, outward from the center of mounting bracket 104 and in a plane perpendicular to both the operating surface and the plane occupied by clamping pads 206, 208. In other embodiments, extendable arms 202, 204 are slidably mounted to mounting bracket 104 in some other fashion that permits the arms to translate in the horizontal direction. Alternatively, extendable arms 202, 204 comprise pistons mounted to the mounting bracket at the proximal ends, coupled to the clamping pads at the distal ends, and capable of horizontal translation. In this manner, extendable arms 202, 204 can slide outward so as to diverge or open clamping pads 206, 208 with respect to one another and receive palletless product units or slide inward or converge the clamping pads with respect to one another so as to clamp or grip product units therebetween.

In some embodiments, extendable arms 202, 204 can each comprise a plurality of elongate members that slide horizontally relative to one another to achieve a maximum open position or divergence between clamping pads 206, 208. In other embodiments, the extendable arms can comprise a plurality of members in telescoping relation to one another. Alternatively, extendable arms 202, 204 can each comprise some other configuration that permits horizontal translation of the arms and/or the clamping pads.

In one preferred embodiment, extendable arms 202, 204 are configured such that clamping pads 206, 208 can diverge with respect to one another and reach an open position whereby the pads are about 96 inches apart or more. Additionally, extendable arms 202, 204 can be configured to close, or converge, clamping pads 206, 208 with respect to one another to a distance of about 28 inches or less. In other embodiments, extendable arms 202, 204 can be configured to diverge or open clamping pads 206, 208 to a greater distance with respect to one another or converge or close the clamping pads to a shorter distance with respect to one another.

In another aspect, the distal ends of extendable arms 202, 204 can be either fixedly or moveably coupled to clamping pads 206, 208, respectively. In one embodiment, the clamping pads are rotatably coupled to the extendable arms such that the pads can be placed at some angle with respect to the operating surface. For example, in one preferred embodiment, clamping pads 206, 208 can be positioned at a neutral or zero camber. As used herein, “neutral” or “zero camber” is meant to describe a configuration wherein the clamping pads are maintained at a position substantially perpendicular, or at a 90 degree angle, with respect to the operating surface and substantially parallel with respect to one another. In other embodiments, the clamping pads can be positioned at some other angle with respect to the operating surface. Alternatively, clamping pads 206, 208 can be fixedly coupled to the distal ends of extendable arms 202, 204. In one preferred embodiment, the clamping pads can be fixed at a neutral or zero camber. In alternative embodiments, the pads can be fixed to the extendable arms such that the pads are maintained at some other angle.

In one aspect, the composition of clamping pads 206, 208, specifically the gripping surfaces 222, 224, can be designed with the specific product to be transported in mind. For example, in one embodiment, gripping surfaces 222, 224 can be comprised of a relatively flexible or soft material where a product such as tissue is to be transported. In other embodiments, the gripping surfaces can comprise a more rigid material. In some embodiments, the gripping surfaces can comprise a rubber material. In other embodiments, the gripping surfaces can comprise, but are not limited to, metal, irathane, or urethane. Additionally, the shape of the gripping surfaces can be modified to suit a particular product to be transported. For example, gripping surfaces 222, 224 can comprise ridges, ribs, slots, holes, or numerous other modifications. Further, gripping surfaces 222, 224 can exhibit various surface textures. In some embodiments, the gripping surfaces can be relatively smooth, exhibiting a low coefficient of friction. In other embodiments, the gripping surfaces can be relatively rough and have a higher coefficient of friction.

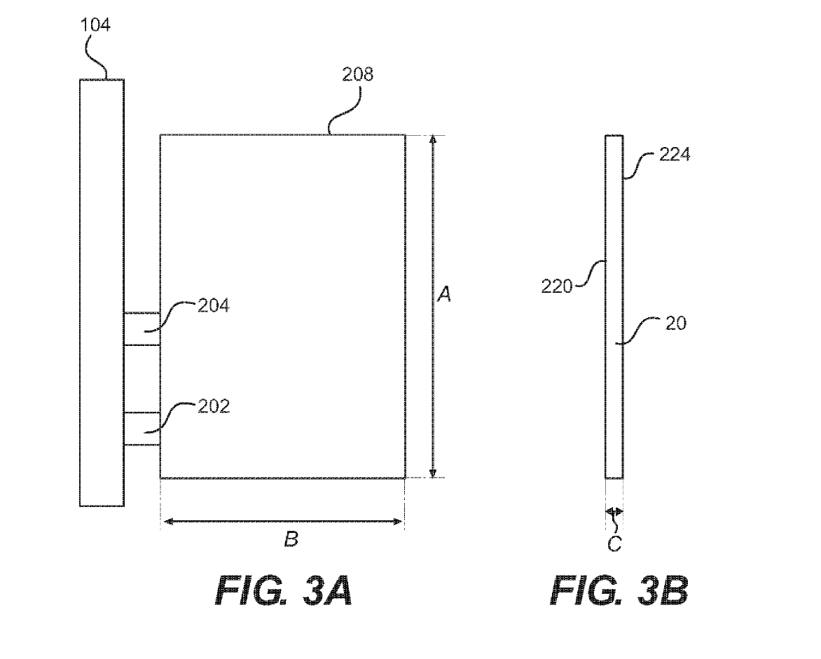

In another aspect, clamping pads 206, 208 can be of a size and rigidity suitable for providing the necessary stability and flexion for transporting a particular palletless product. FIGS. 3A and 3B depict clamping pad 208 in more detail. In some embodiments, clamping pads 206, 208 can be substantially rectangular in shape. Specifically, in one preferred embodiment, clamping pads 206, 208 are about 48 to about 60 inches in height (depicted as measurement A), about 40 to about 54 inches in length (depicted as measurement B), and about 5 inches thick (depicted as measurement C). In other embodiments, the clamping pads can be smaller, larger, thicker, or thinner. Alternatively, the clamping pads can be convex or concave in shape rather than substantially flat. In another aspect, the corners and/or edges of the clamping pads can be shaped to improve their functionality. For example, in some embodiments the corners and/or edges of clamping pads 206, 208 can be rounded to prevent damage or creasing to the product units to be transported.

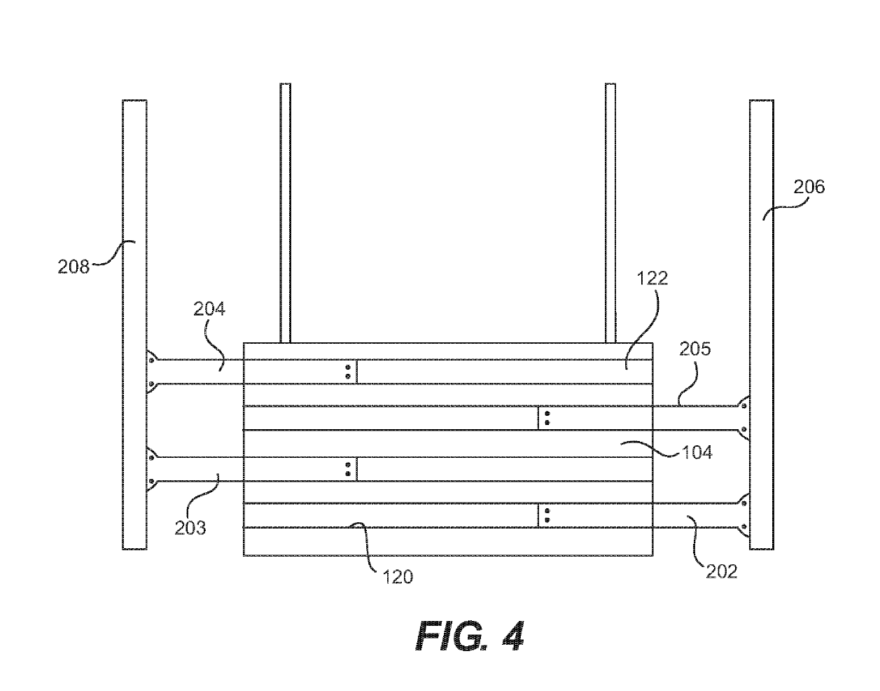

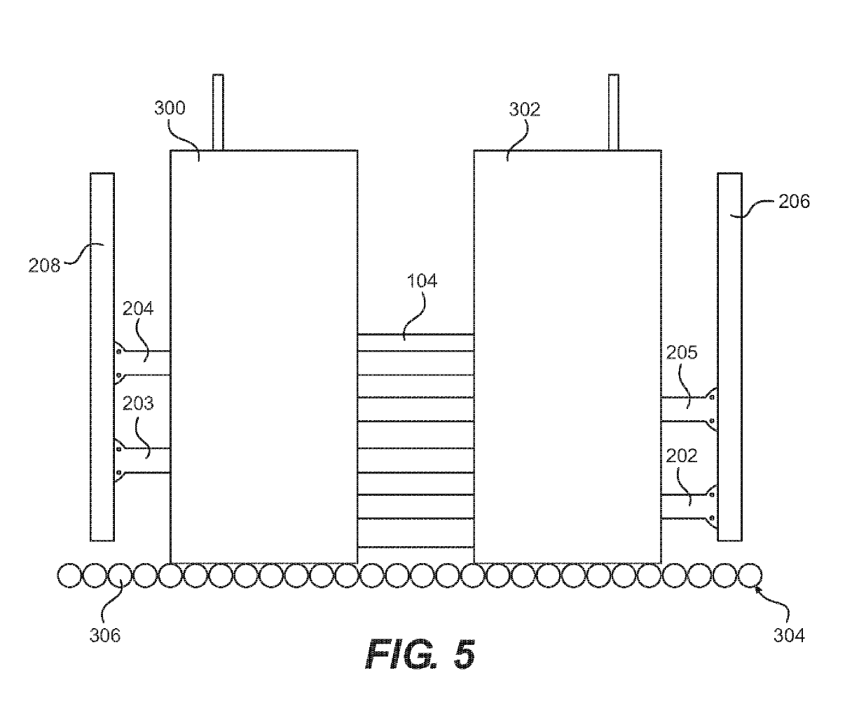

FIGS. 4 and 5 depict extendable arms 202, 204 and clamping pads 206, 208 in an open state, with extendable arms horizontally translated outward from the center of mounting bracket 104 and the pads positioned to receive palletless product units therebetween. Additionally, in the embodiment depicted, manipulation system 200 comprises an additional pair of extendable arms 203, 205. In one aspect, extendable arms 203, 205 are substantially similar to previously described extendable arms 202, 204. In one embodiment, the extendable arms are configured such that extendable arms 203 and 204 translate both outward and inward together or in a synchronized fashion. Similarly, extendable arms 202 and 205 can be configured to translate outward and inward together.

In another aspect, depicted in FIG. 5, a user 108 can utilize vehicle controls 106 to position vehicle 102 and manipulation system 200 proximate to a pair of palletless product units 300, 302, which are positioned one next to the other and supported by operating surface 304. In one embodiment, operating surface 304 can be comprised of rollers 306, which allow product units 300, 302 to be moved across the operating surface with lesser force or decreased effort. In other embodiments, operating surface 304 can comprise a conveyor belt, a storage facility floor, or some other surface. Next, the user can position clamping pads 206, 208 on either side of the product units by utilizing manipulation controls 116. In one embodiment, the user first positions clamping pads 206, 208 at the appropriate height by adjusting the vertical position of mounting bracket 104. Then the user can open the clamping pads such that the pads are sufficiently separated for the product units to fit therebetween. Next, the user can reposition vehicle 102 and/or mounting bracket 104 such that the product units are between clamping pads 206, 208. In one embodiment, the user can also adjust the camber of clamping pads 206, 208. In a preferred embodiment, the user can adjust the clamping pads to exhibit a neutral camber.

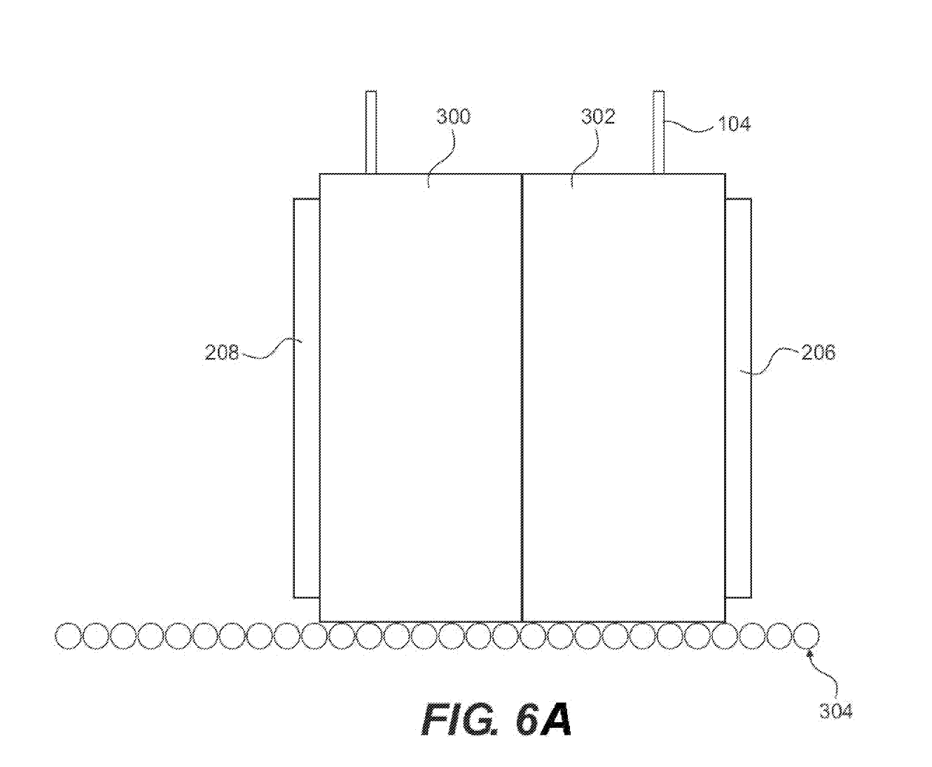

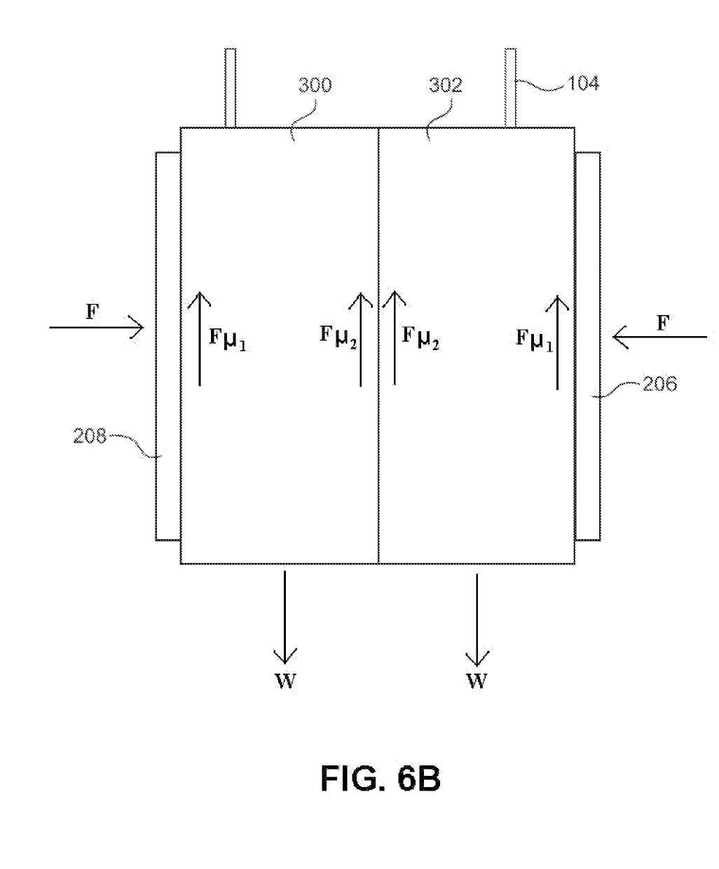

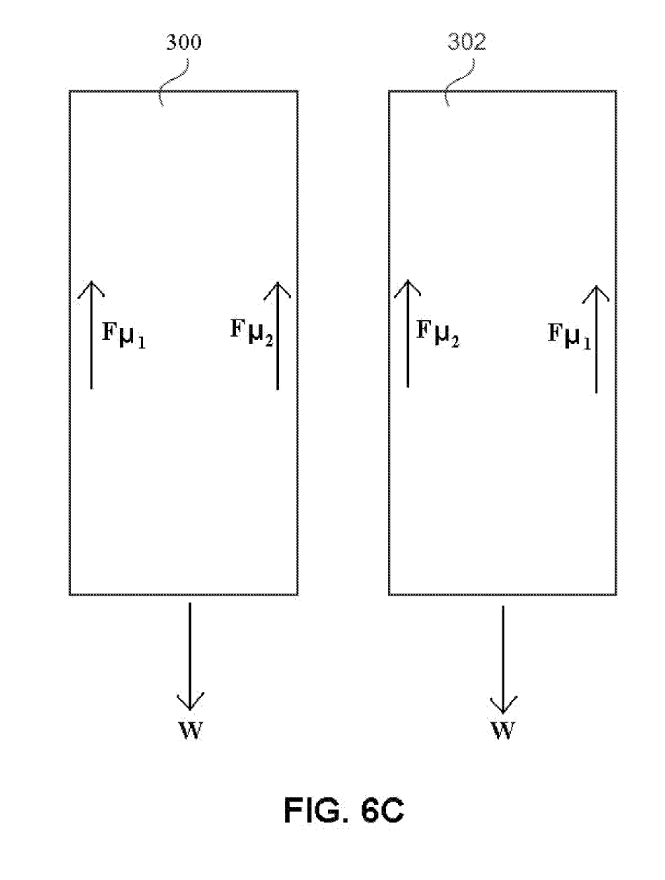

FIG. 6A depicts clamping the product units between the clamping pads in one embodiment. After the pads are positioned on either side of the product units, the user can utilize manipulation controls 116 to translate extendable arms 202, 204 such that the clamping pads converge until they make contact with and exert sufficient force on the outer walls of the product units. The force required to adequately secure the product units for transport will depend on a number of variables, such as, but not limited to, the nature of the product to be transported, the weight of the product units, the surface area of the clamping pads, the surface properties of the clamping surface of the pads, the surface properties of the product units, and the camber of the pads.

For example, in one preferred embodiment, the product units to be transported comprise two paper product units. Additionally, the coefficient of friction between the gripping surfaces of the clamping pads and the surface of the product units can be μ₁, and the coefficient of friction between the two product units can be μ₂. Further, the camber of the clamping pads can be set to neutral. Thus, a force exerted by the clamping pads on the product units that is great enough to create a friction force between the clamping pads and the product units and between the product units themselves that is great enough to lift the product units can be calculated.

FIGS. 6B and 6C depict the interaction of the various forces in one exemplary embodiment. The force necessary to lift the two product units, assuming they are of a substantially same weight, can be determined using the formula:

Fμ1+Fμ2≧W

where F is the force exerted by the clamping pads, μ1 is the coefficient of friction between the gripping surfaces and the product units, μ2 is the coefficient of friction between the product units, and W is the weight of each product unit.

Additionally, the pressure exerted by the clamping pads should not be so great as to cause damage or creasing to product units 300, 302. Pressure is calculated using the formula:

P=F/A

where F is the force exerted by the clamping pads, A is the surface area of the gripping surface of the pads, and P is the resulting pressure on the product units.

Thus, the force exerted on the clamping pads must be sufficiently great to lift the product units off the operating surface, while the surface area of the gripping surface on the clamping pads must be sufficiently large to distribute the clamping force over a large enough surface area so as not to crease or damage the product units. In one embodiment, the surface area of the clamping pads can be equal to about 3,240 square inches, the clamping pad having a height of about 60 inches and a length of about 54 inches. In other embodiments, the clamping pads can be selected to have a smaller or larger surface area and different height and length dimensions.

In other embodiments, the surface area of the clamping pads, the height and length of the clamping pads, the coefficient of friction between the gripping surfaces and the product units or between the product units themselves, or the camber of the clamping pads can be altered. As a result, the force to be exerted by the clamping pads necessary to lift the product units without causing damage will be different.

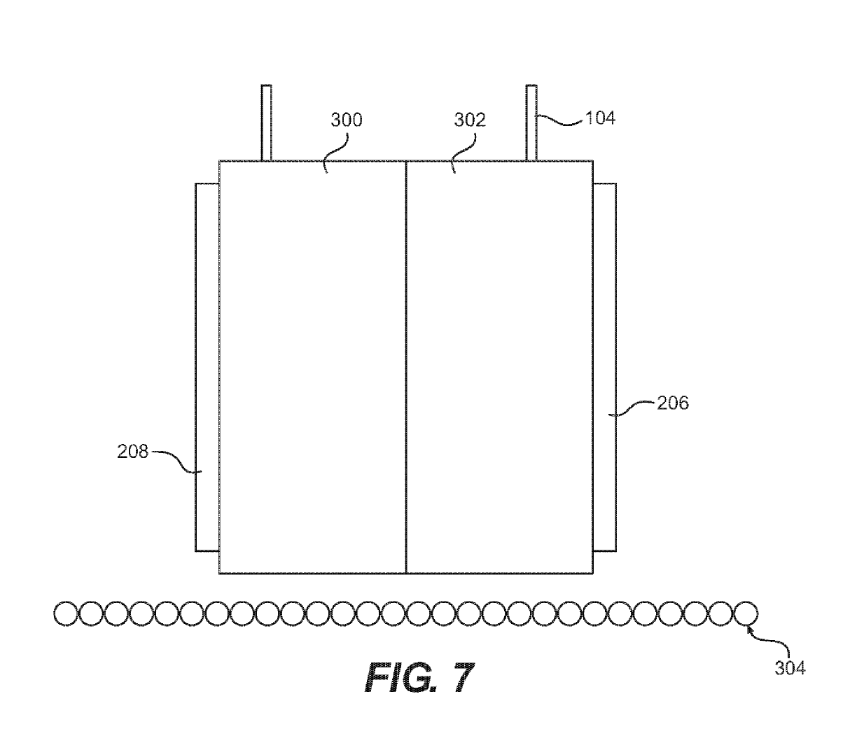

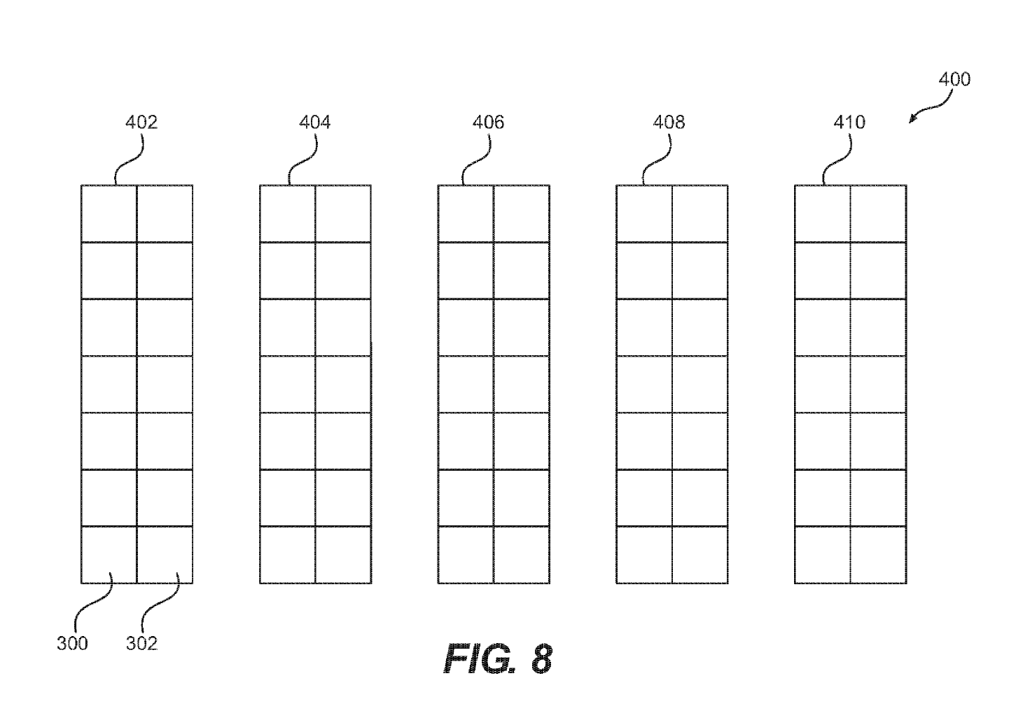

Once the product units are secured between clamping pads 206, 208 using sufficient pressure to create an adequate friction force between the clamping pads and the product units, they can be lifted vertically off operating surface 304 and prepared for transport. FIG. 7 depicts product units 300, 302 lifted from operating surface 304. In one embodiment, user 108 can use manipulation controls 116 to translate mounting bracket 104 vertically so as to raise the mounting bracket sufficiently to lift the bottom surface of the product units off the operating surface. In another embodiment, where clamping pads 206, 208 and/or extendable arms 202, 204 are pivotally coupled to mounting bracket 104, the user can use manipulation controls 116 to pivot the clamping pads and/or the extendable arms such that the bottom surface of product units 300, 302 is lifted off of operating surface 304. Similarly, in embodiments where the mounting bracket is pivotally coupled to vehicle 102, the user can use the manipulation controls to pivot the mounting bracket such that the product units are lifted off the operating surface. Alternative embodiments can employ a different method of lifting the product units off of the operating surface.

Once product units 300, 302 are secured between clamping pads 206, 208 and lifted from operating surface 304, they can be transported to a desired location. For example, they can be transported at various stages in the manufacturing, distribution, or storage process. FIG. 8 depicts a storage facility 400 wherein a plurality of product units can be temporarily stored. In one embodiment, the product units can be stored in a double-wide configuration. In one aspect, because the product units are transported in side-by-side relation, and can be similarly stored, more product units can be stored in one facility because the product units do not have to be placed in single-file columns. In this manner, sufficient space is left between the plurality of columns to accommodate the positioning of clamping pads 206, 208 therein for future transportation of the stored product units. This product unit spacing can result in a large increase in the storage capacity of facility 400. In other embodiments, different storage configurations of the product units can be used to increase the storage capacity of the storage facility.

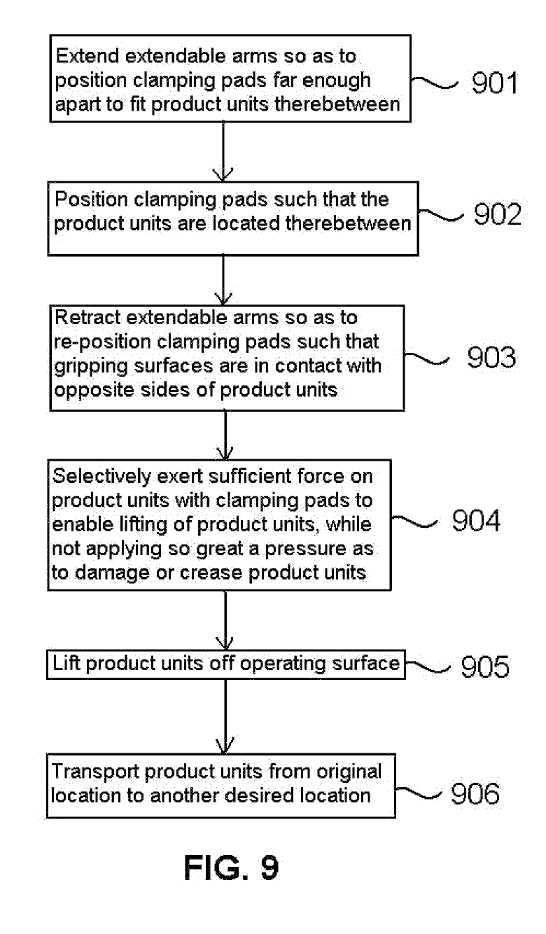

FIG. 9 depicts the steps taken in one embodiment of the invention. In a first step 901, the user 108 can utilize manipulation controls 116 to selectively extend extendable arms 202, 204 so as to position clamping pads 206, 208 far enough apart to fit product units 300, 302 therebetween. In a next step 902, the user can then again utilize manipulation controls 116 or vehicle 102 to position clamping pads 206, 208 such that the product units are between the clamping pads and the pads are disposed on opposite sides of the group of product units. Next, in step 903, the user can contract the extendable arms so as to re-position the clamping pads such that gripping surfaces 222, 224 are in contact with the opposite sides of the product units. Step 904 can comprise the user selectively exerting sufficient force on the product units with the clamping pads to enable lifting the product units off of operating surface 304. Concurrently, and depending on the surface area of the gripping surfaces, the user can also use a force that will not result in so great a pressure on the product units so as to cause creasing or damage to the product units. In step 905, the user can again utilize manipulation controls 116 to lift the product units vertically off the operating surface. And in step 906, the user can use vehicle controls 106 to re-position vehicle 102 and thereby transport the product units from their original location to a second desired location, such as to a storage facility, and placed in a desired configuration (e.g., the double-wide configuration shown in FIG. 8).

All the embodiments of the invention discussed above can be used to transport and store palletless product units during manufacturing, distribution, and storage processes. A method of use can comprise the provision of one of the palletless product handling vehicles described above to secure and then transport a plurality of palletless product units from one location to another.

Additional features can also be incorporated into the palletless product handling vehicle to improve its functionality. For example, manipulation controls 116, clamping pads 206, 208, and/or extendable arms 202, 204 can comprise a pressure, force, or displacement sensor for detecting the amount of force being applied to the product units between the clamping pads and alerting the user of the device when an adequate amount of force has been applied for securing the units for transport. In other embodiments, the device can comprise safety features for automatically stopping the vehicle and lowering the product units being transported to ground level if a sensor detects the product units being transported are no longer adequately secured. Further, the mounting bracket, extendable arms, and/or clamping pads described above can comprise additional degrees of freedom. For example, via manipulation controls 116, the user can secure the product units between the clamping pads and then rotate mounting bracket 104, extendable arms 202, 204, and/or clamping pads 206, 208 90 degrees, or some other degree of rotation. In this manner, the product units can be reoriented after being lifted off operating surface 304 for easier transport or more efficient storage.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. An improved manipulation system for handling a plurality of palletless product units disposed proximate to each other and having side surfaces on opposing sides of the plurality of palletless product units, the system comprising:
a mounting bracket configured to be attached to a motorized vehicle;
a first and second extension arm, each of the first and second extension arms being coupled to the mounting bracket and selectively movable relative to the mounting bracket;
a first clamping pad coupled to the first extension arm, the first clamping pad having a first gripping surface;
a second clamping pad coupled to the second extension arm, the second clamping pad having a second gripping surface;
wherein the orientation of each of the first and second clamping pads are selectively chosen to optimize a pressure placed upon the side surfaces of the plurality of palletless product units from the first and second gripping surfaces as the first and second clamping pads are disposed proximate to the opposing sides and converge with respect to each other, the orientation of the first and second clamping pads and the optimized pressure selected such that the manipulation system can lift the plurality of palletless product units between the first and second clamping pads without creasing the opposing sides of the plurality of palletless product units.

2. The manipulation system of claim 1 wherein the orientation of the first and second clamping pads exhibit a neutral camber.

3. The manipulation system of claim 2, wherein the first and second gripping surfaces are about 48 inches to about 60 inches in height.

4. The manipulation system of claim 2, wherein the first and second gripping surfaces are about 40 inches to about 54 inches in length.

5. The manipulation system of claim 2, wherein the first and second clamping pads are about 5 inches thick.

6. The manipulation system of claim 1, wherein the first and second extension arms are selectively moveable such that the first and second gripping surfaces can be positioned at least about 96 inches apart.

7. The manipulation system of claim 1, wherein the first and second extension arms are selectively moveable such that the first and second gripping surfaces can be positioned at about 28 inches apart or closer.

8. The manipulation system of claim 1, wherein the plurality of palletless product units comprise paper product units.

9. The manipulation system of claim 8, wherein the plurality of product units comprise tissue product units.

10. A method of securing and transporting a plurality of palletless paper product units at one time, comprising:
selectively extending a first and a second extension arm relative to a mounting bracket, the first and second extension arms being coupled to a first and a second clamping pad, respectively, and the extension arms being configured such that the clamping pads can be spaced 96 inches apart in an open position and spaced 28 inches apart or less in a closed position;
positioning the first and second clamping pads on opposite sides of a plurality of palletless product units;
clamping the plurality of product units between the first and second clamping pads with a force sufficient to transport the product units while exerting a pressure on the product units that will not crease or damage the product units;
lifting the plurality of product units vertically; and
transporting the plurality of product units from a first location to a second location.

11. The method of claim 10, wherein the plurality of product units comprise paper product units.

12. The method of claim 11, wherein the plurality of product units comprise tissue product units.

13. The method of claim 10, wherein the first and second clamping pads are maintained at a substantially neutral camber throughout the clamping and lifting steps.

14. A method of transporting and storing a plurality of product units comprising:
selecting a first and a second extension arm, each coupled to a first and second clamping pad, respectively, and configured such that the clamping pads can diverge and converge with respect to one another, the first and second clamping pads having a first and a second gripping surface, respectively;
positioning the first and second clamping pads on opposing sides of the plurality of product units;
clamping the plurality of product units between the first and second clamping pads with adequate force to lift the product units, the surface area of the gripping surfaces of the clamping pads being selectively chosen to optimize the pressure exerted on the opposing sides of the plurality of product units so as not to crease the product units;
lifting the plurality of product units;
transporting the plurality of product units to a storage facility;
storing the plurality of products in a plurality of rows, the rows being a number of product units wide equal to the number of product units in the plurality of product units.

15. The method of claim 14 wherein the first and second extension arms are configured such that the clamping pads can diverge to a distance of about 96 inches or more.

16. The method of claim 14 wherein the first and second extension arms are configured such that the clamping pads can converge to a distance of about 28 inches or less.

17. The method of claim 14 wherein the first and second clamping pads exhibit a neutral camber during the clamping and lifting steps.

18. The method of claim 14 wherein each of the first and second gripping surfaces comprise a surface area of at least about 3,000 square inches.

19. The method of claim 14, wherein the first and second gripping surfaces are about 48 inches to about 60 inches in height.

20. The method of claim 14, wherein the first and second gripping surfaces are about 40 inches to about 54 inches in length.
